(19) United States
(12) Patent Application Publication
(10) Pub. No.: US 2017/0011312 A1
(43) Pub. Date: Jan. 12, 2017

(54) Predicting Work Orders For Scheduling Service Tasks On Intrusion And Fire Monitoring

(71) Applicants: Gopi Subramanian, Whitfield (IN); Christine Trainor, Birmingham, AL (US); Michael Stewart, Cypress, CA (US)

(72) Inventors: Gopi Subramanian, Whitfield (IN); Christine Trainor, Birmingham, AL (US); Michael Stewart, Cypress, CA (US)

(73) Assignee: Tyco Fire & Security GmbH, Neuhausen am Rheinfall (CH)

(21) Appl. No.: 14/792,901

(22) Filed: Jul. 7, 2015

(51) Int. Cl. G06Q 10/04; G06Q 10/06; G06F 17/27

(52) U.S. Cl. CPC G06Q 10/04; G06F 17/2705; G06F 17/2775; G06Q 10/06311; G06Q 10/067

(57) ABSTRACT

A work order prediction system is described. The system includes computers that implement a recommendation engine that receives historical job records from customer jobs and produces a listing of rules comprising rules of the form A→B or A,B→C or A,B>C, D, where A, B, C, D are work order jobs and a calculated confidence value for a result of each of the rules. The system includes a key phrase extraction module and a site similarity computation module, which feed a prediction engine that generates a prediction of a work order and basis of the prediction.

### BACKGROUND

This description relates to operation of security systems in particular intrusion detection and fire monitoring systems.

It is common for businesses and homeowners to have a security system for detecting alarm conditions at their premises and signaling the conditions to a monitoring station or to authorized users of the security system. Security systems often include an intrusion detection panel that is electrically or wirelessly connected to a variety of sensors. Those sensors typically include motion detectors, cameras, and proximity sensors (used to determine whether a door or window has been opened). Other types of security systems include access control and surveillance systems typically used by commercial businesses.

Service products such as “MAStermind” (United Technologies, Inc.) help service customer work orders. For a typical service request on a security system, a service dispatch center in a physical location produces a work order upon receipt of a customer complaint. The complaint can be regarding a false alarm or an issue with the respect to any of the devices or panels installed in their premises. Dispatch center personnel produce the work order request using the service product and schedules a technician to visit the site. The visiting technician inspects the premises and updates service center personnel about the problem. The work order is updated with the correct job cause/description. The technician may perform several tasks on the security system to solve the customer complaint. Each task is added as a line item by the service product and associated with the job. When the job is completed an appropriate job resolution description is selected for the job and comments from technicians or the service center personnel are added as free text.

### SUMMARY

The problem with this type of servicing when applied to intrusion detection and alarm security systems is that a technician and service truck are sent to the customer premises for almost every line item in the job and can involve an average more than one dispatch per job. In addition to more dispatches, other problems also arise such as finding the right technicians for the job, having the right parts in the service truck and isolating the problem quickly. Excess truck dispatches have other consequences such as environmental and health and safety issues because of excessive truck dispatches (more vehicle emissions and increased risk of road accidents). Jobs that take longer to complete can erode a security business's service contract profit margins. Other qualitative issues that can arise include, unsatisfied customers and technicians because of ad-hoc scheduling of service calls with the wrong technician skills or inadequate equipment/supplies needed to complete a job.

According to an aspect, a work order prediction system includes one or more servers computers each comprising a processor device, memory in communication with the processor device, and a storage device, the work order prediction system further including a recommendation engine that receives historical job records from customer jobs and produces a listing of rules comprising rules of the form A→B or A,B→C or A,B>C, D, where A, B, C, D are work order jobs and calculates a confidence value for a result of each of the rules, a key phrase extraction module that receives as input free text that is parsed from the historical job records, a site similarity computation module that clusters similar sites together, prediction engine that generates a prediction of a work order and basis of the prediction and graphical user interface module that generates a graphical user interface to convey to dispatch personnel an intuitive representation of the basis of the prediction.

The work order prediction system analyzes historical job details for a customer site and generates the model that predicts future jobs within a limited time frame that can be expected for the customer site. The recommendation engine includes a feature generator and a model builder. The model builder in the recommendation engine executes an algorithm the frequent item set data mines the retrieved, historical work order records for job details for a customer site. The algorithm is the Apriori algorithm that identifies frequent individual job cause numbers in the work order records and that produces rules of the form A→B or A,B→C or A,B>C, D, where A, B, C, D are job cause numbers extracted from the work order records. The feature generator orders the historical work order records by site and then by the date of job creation, scans sequentially the work order records and all job cause numbers that are within a preconfigured time window and groups all job cause numbers that are within the defined time window, as one transaction record of job cause numbers. The prediction engine retrieves a list of recent job causes for a given site, scans the list of rules generated by the recommendation engine against recent job causes for the site; when the prediction engine finds matches to any of the job causes the prediction engine selects a corresponding output of the rule as the prediction.

When the prediction engine does not find any matching rules, the prediction engine, accesses output of the site similarity computation module, scans the output for similar sites, and scans the rules in the output to find a match for a prediction. When the prediction engine determines a match, the prediction engine uses the result of the matching rule as the prediction and queries the key phrase extraction module for key phrases associated with the matched rule.

According to an additional aspect, a computer implemented method for work order prediction includes forming a recommendation by one or more computer systems from received historical job records from customer jobs comprising rules of the form A→B or A,B→C or A,B>C, D, where A, B, C, D are work order jobs with a calculated a confidence value for a result of each of the rules, producing by the one or more computer systems a listing of the rules, extracting by the computer system one or more key phrases that are received as input free text parsed from the historical job records, producing by the one or more computer systems a site similarity computation that clusters similar sites together, generating by the one or more computers a prediction of a future work order and basis of the prediction, and generating by the one or more computers a graphical user interface to convey to dispatch personnel a representation of the basis of the prediction.

According to an additional aspect, a computer program product tangible stored on a computer readable hardware storage device, the computer program product for providing a work order prediction and comprising instructions to cause one or more servers computers each comprising a processor device, memory in communication with the processor device, and a storage device to receive from a database historical job records from customer jobs, produce a recommendation as a listing of rules of the form A→B or A,B→C or A,B>C, D, where A, B, C, D are work order jobs and an associated a confidence value for a result of each of the rules, extract key phrases from free text that is parsed from the historical job records, produce site similarity clusters of similar sites into groups of similar sites, form a prediction of a work order and basis of the prediction, and generate a graphical user interface to convey to dispatch personnel a representation of the basis of the prediction.

The above techniques can include additional features and one or more of the following advantages.

The above techniques can be used to provide predictions of what jobs will occur in the near future at a customer site based on historical jobs. In addition to notifying dispatch personnel about a predicted job, the techniques provides the dispatcher with details about the predicted job, thus helping a dispatcher to properly plan and prepare to schedule a technician's visit to the customer site.

The details of one or more embodiments of the invention are set forth in the accompanying drawings and the description below. Other features, objects, and advantages of the invention is apparent from the description and drawings, and from the claims.

### DESCRIPTION OF DRAWINGS

FIG. 1 is a schematic diagram of an example security system at premises.

FIG. 2 is a block diagram of an intrusion detection panel.

FIG. 3 is a block diagram showing an example of an access control system.

FIG. 4 is a block diagram of a work order prediction system.

FIG. 5 is a flow diagram of an example algorithm.

FIG. 6 is a flow diagram of an example recommendation engine.

FIG. 7 is a flow diagram of an example key phrase extraction engine.

FIG. 7A is a diagram of a word cloud.

FIG. 8 is a flow diagram of an example site similarity engine.

FIG. 9 is a flow diagram of an example prediction engine.

FIG. 10 is a flow diagram of a GUI module.

FIG. 10A is a diagram of a GUI.

FIG. 11 is block diagram of details of a device/system

### DETAILED DESCRIPTION

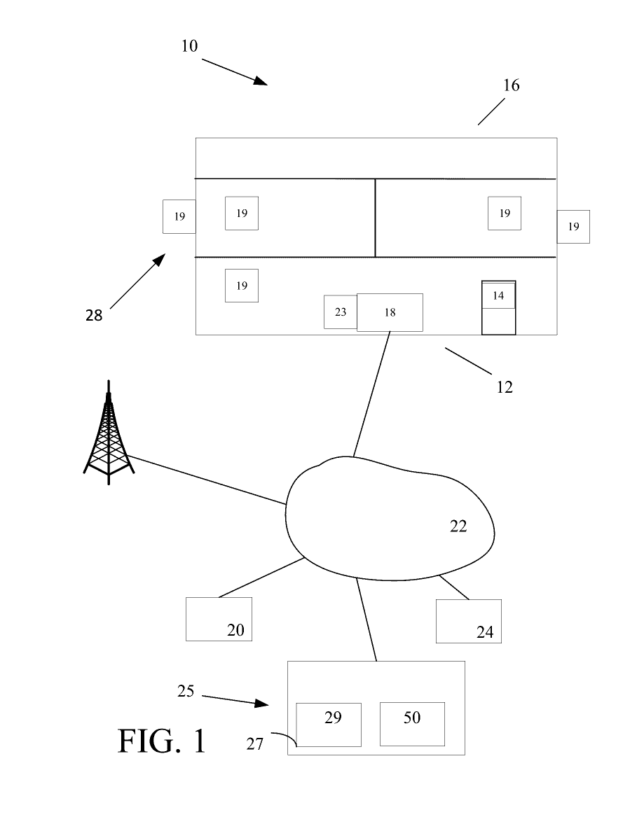

Referring now to FIG. 1, an example application 10 of a security system in particular an intrusion detection system 12 and access control system 14 installed at a premises 16 is shown. In this example, the premises 16 is commercial premises, but the premises may alternatively be any type of premises or building, e.g., residential, industrial, etc. The intrusion detection system 12 includes an intrusion detection panel 18, and sensors/detectors 19 disbursed throughout the premises 16. The intrusion detection system 12 is in communication with a central monitoring station 20 (also referred to as central monitoring center) via one or more data or communication networks 22 (only one shown), such as the Internet; the phone system or cellular communication system being examples of others. The intrusion detection panel 18 receives signals from plural detectors/sensors (generally referred to as 19) that send to the intrusion detection panel 18 information about the status of the monitored premises.

Several types of sensor/detectors (terms used interchangeably herein) can be used such as microphones, motion detectors, smart switches and cameras. The detectors 19 may be hard wired or communicate with the intrusion detection panel 18 wirelessly. In general, detectors 19 sense glass breakage, motion, gas leaks, fire, and/or breach of an entry point, and send the sensed information to the intrusion detection panel 18. Based on the information received from the detectors 19, the intrusion detection panel 18 determines whether to trigger alarms, e.g., by triggering one or more sirens (not shown) at the premises 16 and/or sending alarm messages to the monitoring station 20.

A user may access the intrusion detection panel 18 to control the intrusion detection system, e.g., disarm the intrusion detection system, arm the intrusion detection system, enter predetermined settings, etc. The access can be made directly at the premises 16, e.g., through a keypad 23 connected to the control panel, through a remote device 24, etc.

The data or communication network 24 may include any combination of wired and wireless links capable of carrying packet and/or switched traffic, and may span multiple carriers, and a wide geography. In one embodiment, the data network 22 may simply be the public Internet. In another embodiment, the data network 22 may include one or more wireless links, and may include a wireless data network, e.g., with tower (not referenced) such as a 2G, 3G, 4G or LTE cellular data network. The panel 16 may be in communication with the network 22 by way of Ethernet switch or router (not illustrated). The panel 16 may therefore include an Ethernet or similar interface, which may be wired or wireless. Further network components, such as access points, routers, switches, DSL modems, and the like possibly interconnecting the panel 16 with the data network 22 are not illustrated.

Also shown in FIG. 1 is a dispatch center 25. The dispatch center 25 includes personnel stations (not shown), a server(s) system 27 running a service fulfillment program 29 that populates a database (not shown) with historical data and a work order prediction system 50.

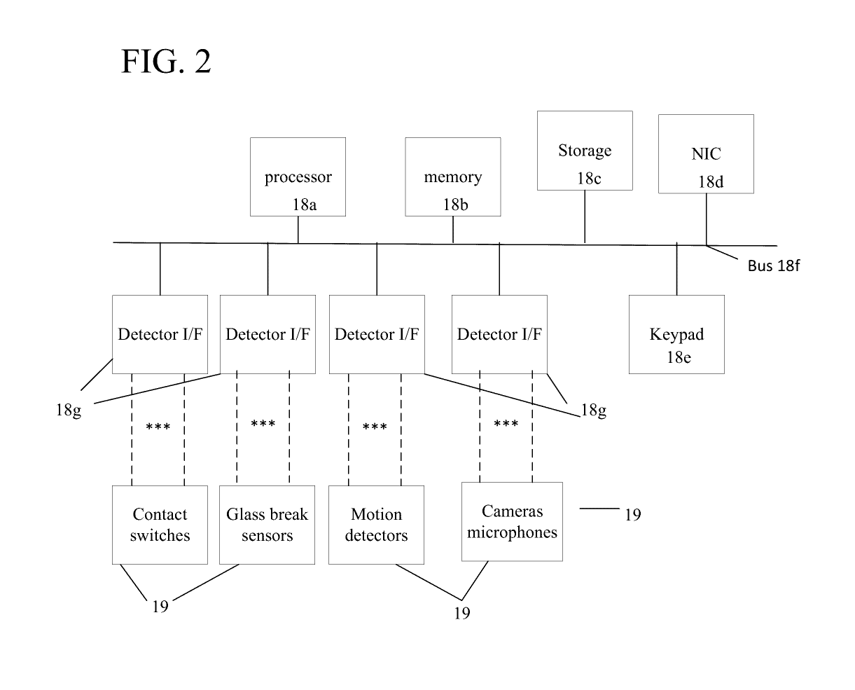

Referring now to FIG. 2, details on an exemplary intrusion detection system including the panel 18 are shown. The intrusion detection panel 18 includes processor 18a and memory 18b, storage 18c, a key pad 18d and a network interface card (NIC) 18e coupled via a bus 18f. The intrusion detection panel 18 also includes one or more interfaces 18g to receive sensor data from the various sensors 19. Illustrated for explanatory purpose are detector interfaces 18g for contact switches, glass break sensors motion detectors, cameras and microphones. Others may be included.

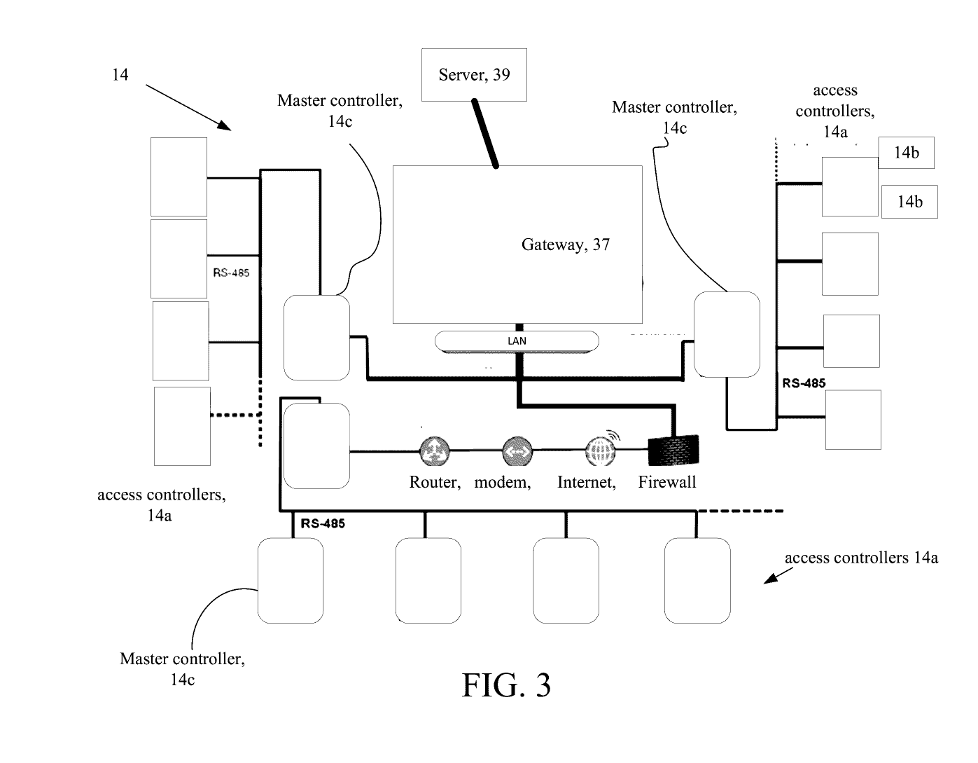

Referring now to FIG. 3, the access control system 14 is shown. Access control systems can be installed in residences but are more commonly installed in businesses. For example, a room (not shown) has a doorway and has associated therein an access controller 14a and one or two card readers 14b, (e.g. an ingress card reader and an egress card reader) with door locks (not shown) controlled by the access controller. The access control system 14 can include a plurality of access controllers 14a and associated card readers 14b.

During installation of the access control system 14, the access controllers 14 are configured by a technician according to operational requirements. The access control system 14 also includes a gateway 15a that is coupled to the access controllers 14a via one or more master controllers 14c, as shown. The access control system 14 also includes a LAN, router, modem, the Internet and cellular or serial communications and a firewall, as illustrated, and a server 15b that is coupled to the gateway 15a.

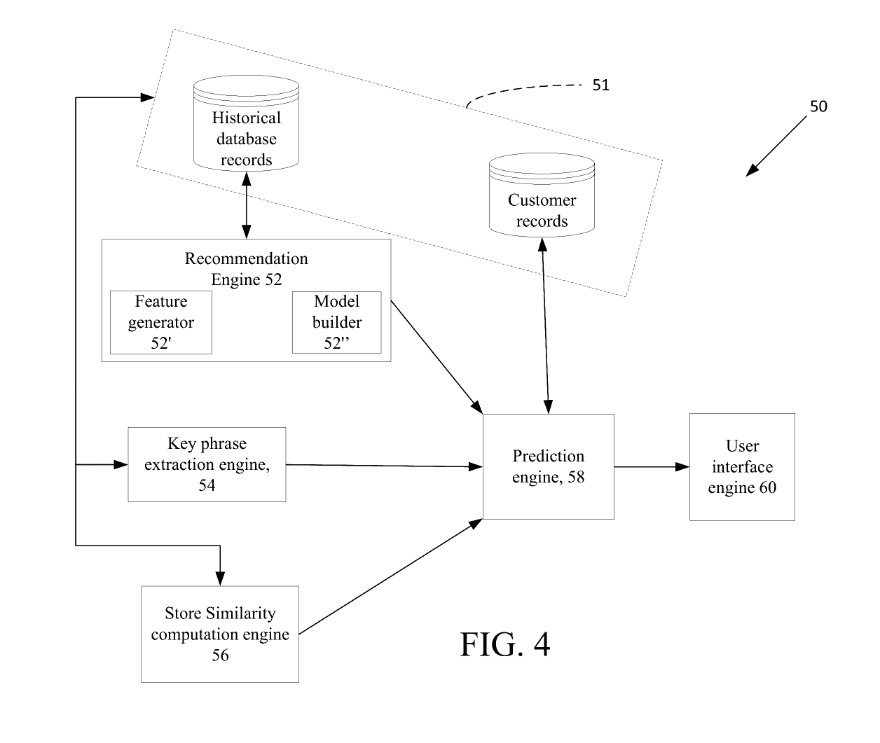

FIGS. 1-3 are examples of security/intrusion/alarm/access control systems. Referring now to FIG. 4, the work order prediction system 50 is shown. The work order prediction system 50 includes one or more server computers either dedicated server computers or cloud server computers and database(s) 51 that store historical job records (discussed below). The work order prediction system 50 analyzes historical job details for a customer and generates a model that can predict future jobs within a limited time frame that can be expected for a customer site. Given, recent past jobs, the model produces a list of predicted future jobs. The work order prediction system 50 produces an intuitive user interface that informs dispatch center personnel about why the model predicts a job and also provides details about the job predicted.

The work order prediction system 50 includes a recommendation engine 52 that receives historical data from various customer jobs and produces a model/rules of the form A→B, or A,B→C or A,B>C, D, where A, B, C, D are work order jobs. Given a recent job A for a particular customer site, the rule forms a prediction of the next job to occur, which in the example of A,B is C. The recommendation engine 52 calculates a confidence value for a result of each of the rules. The confidence value forms an indication of a validity of the predication, e.g., how much “trust” dispatch center personnel can have in the prediction.

The work order prediction system 50 also includes a key phrase extraction module 54. The key phrase extraction module 54 receives as input, free text that is parsed from the historical job records retrieved from database 51. This text may contain important information about the job. The key phrase extraction module 54 extracts phrases, of e.g., several words, e.g., lengths of 2 or 3 words; lengths of 3 or 4 words; or lengths 4 or 5 words, which are considered important to describe the job. The key phrase extraction module 54 feeds results into a prediction engine 58, so that the prediction engine 58 can explain in detail about predicted job to service dispatch personnel.

The work order prediction system 50 also includes a site similarity computation module 56 that receives the historical job records and based on data in those records forms clusters of similar sites. The output of this module is used by the prediction engine 58. The work order prediction system 50 also includes the aforementioned prediction engine 58. The prediction engine 58 receives recent history for a customer site and uses the model/rules from the above recommendation engine 52 to predict future jobs for a given site. The prediction engine 58 is also responsible to educate the user, via graphs and/or text produced by a user interface engine 60, about why a particular prediction is recommended.

The combination of outputs from the recommendation engine 52, key phrase extraction module 54, and prediction engine 56 are used to generate a graphical user interface in the GUI engine 60 that allows dispatch personnel to intuitively understand the basis of the prediction. The inclusion of the key phrase extractor module 54 can provide additional information that can educate the customer about the expected job. The work order prediction system 50 helps dispatch center personnel to make informed decisions about work order scheduling.

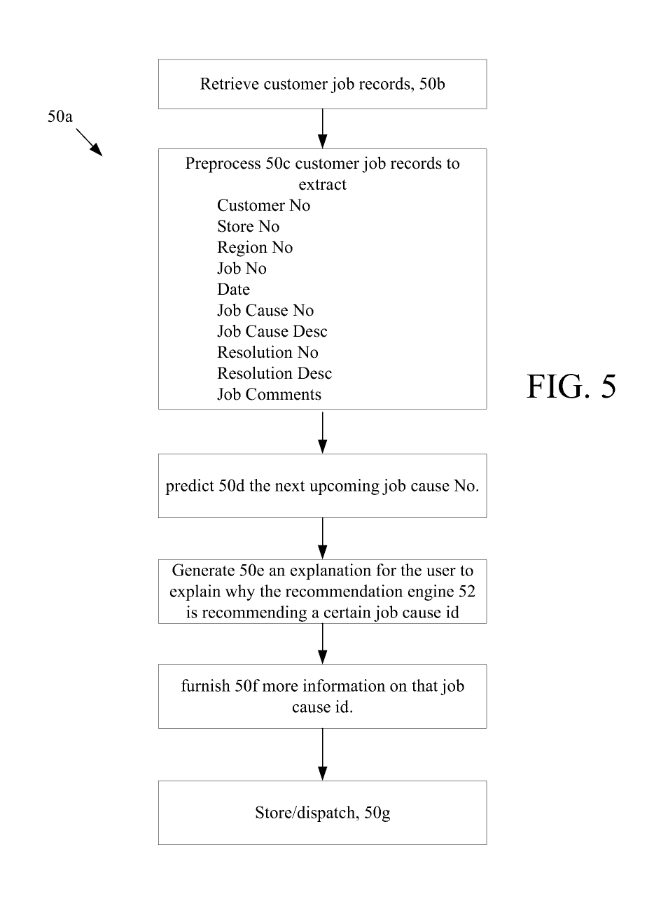

Referring now to FIG. 5, processing 50a of the work order prediction system 50 is shown. The work order prediction system 50 retrieves 50b historical data stored in the database 51, which is generated from a third party service program such as the one mentioned above. This data has records for all customers that a particular integrated security company services. This historical data is retrieved by the recommendation engine 52 in the work order prediction system 50. Typically, such data is available in multiple tables in a normalized form. The data is preprocessed 50c from certain tables and certain columns to capture the following columns of data. The particulars of what tables and columns are captured will vary according to setups of the third party service program used. In addition, names associated with the data are illustrative and non-limiting in that similar functional data is typically found for all such systems, but may be named differently. In one example the following data are captured.
Field Name Field Description
Customer No: Uniquely identifies a customer
Site No: Uniquely identifies a customer site/store
Region No: Sites are categorized into regions, this uniquely identifies a region
Job No: Uniquely identifies a job
Date: Date job created
Job Cause Number: A number that identifies a particular reason why the job was requested.
Job Cause Desc: A textual description of the job cause, for example, “Faulty part”
Resolution No: The resolution that was used to fix the problem.
Resolution Desc: A textual description of the fix.
Job Comments: A free text field, where the job done is described by the technician.

With an understanding of the above data, the work order prediction system 50 using historical job cause numbers (for a given site) generates (via recommendation engine 52) a prediction 50d of the next upcoming historical job cause number based on a set of job cause Nos. that includes a most recent number of job cause id's for that site. The work order prediction system 50 generates 50e an explanation for the user to explain why the recommendation engine 52 is recommending a certain job cause number, and furnishes 50f more information on that job cause number. The results can be stored and forwarded 50g to dispatch personnel systems in the form of a graphical user interface.

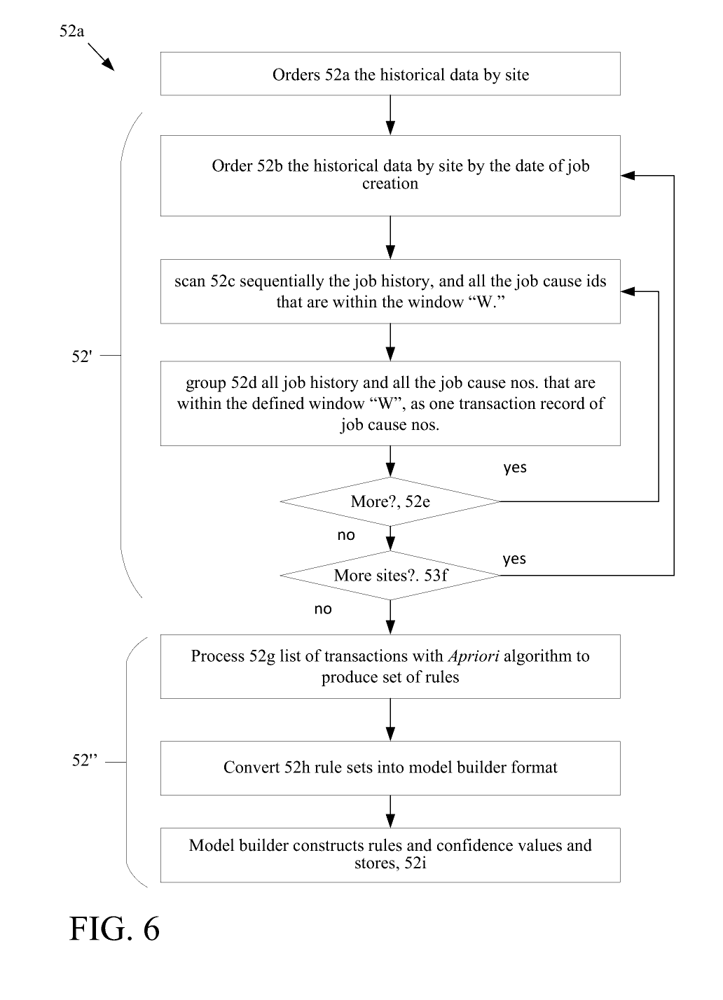

Referring now to FIG. 6, the recommendation engine 52 uses the historical job numbers for a given site to predict the next upcoming job cause number for that site. In other words, the recommendation engine attempts to predict what type of service or service will be required at a particular site based on historical data. Recommendation engine 52 includes a feature generator 52′ and a model builder 52″. Jobs are performed at customer premises sequentially and records of these jobs are stored. The recommendation engine 52 executes an algorithm to analyze these job records to form predictions. The algorithm used is the so called Apriori algorithm that is commonly found in “market basket” or affinity analysis. An Apriori algorithm is used for frequent item set data mining and association learning in transactional databases. The historical records in database 51 can be considered as a transactional database containing work order records. The Apriori algorithm proceeds by identifying frequent individual items in a database and extending the frequent individual items to larger and larger item sets as long as the frequent individual items sets appear sufficiently often in the database 51. The frequent item sets determined by Apriori algorithm are used to determine the rules mentioned above, i.e., association rules that highlight general trends in the data found in the database 51. Other techniques could be used including Random Forest and Multi-linear Logistic Regression algorithms.

Recommendation engine 52 processing 52a is shown using the feature generator 52′ and the model builder 52″. The feature generator 52′ in the recommendation engine 52 orders 52a the historical data by site and then by the date of job creation 52b. The feature generator 52′ in the recommendation engine 52 is preconfigured with a defined time window of size “W.” This time window is typically defined in terms of a week. However, other window sizes could be used. For illustration, the window is defined in terms of a week, so a value of “W=4” refers to a window size of four weeks. The feature generator 52′ scans 52c sequentially the job history, and all the job cause ids that are within the window “W.” The feature generator 52′ groups 52d all job history and all the job cause nos. that are within the defined window “W”, as one transaction record of job cause nos. The feature generator processes the data for all job cause numbers 52e for all sites 52f.

Assume as an example the four following fictitious records:
Customer No: CUST 12345
Site No: ACD
Region No: Region A
Job No : Job 5
Date: JAN. 15, 2015
Job Cause No: 12
Job Cause Desc: “Faulty part”
Resolution No: a20
Resolution Desc: replaced access module.
Job Comments: the access control module in location A34 shorted out
Customer No: CUST 12345
Site No: ACD
Region No: Region A
Job No : Job 6
Date: JAN. 17, 2015
Job Cause No: 45
Job Cause Desc: “no power to access control module”
Resolution No: a75
Resolution Desc: replaced fuse.
Job Comments: the access control module in location A34 did not receive power
Customer No: CUST 12345
Site No: ACD
Region No: Region A
Job No : Job 6
Date: JAN. 17, 2015
Job Cause No: 67
Job Cause Desc: “Faulty power supply”
Resolution No: a16
Resolution Desc: replaced access module power supply.
Job Comments: the power supply in access control module in location A34 shorted out
Customer No: CUST 12345
Site No: ACD
Region No: Region A
Job No : Job 6
Date: JAN. 19, 2015
Job Cause No: 18
Job Cause Desc: “reprogrammed access control module”
Resolution No: a20
Resolution Desc: reprogrammed access module.
Job Comments: the access control module in location A34 needed to be reprogramed

With the feature generator 52′ in the recommendation engine 52 sequentially scanning the job history for “CUST 12345, all the job cause ids within the window W=4 provides:

Job cause Nos. (12, 45, 67, 18).

These job cause Nos. are grouped as a transaction. At the end of processing of all of the historical data 52f through the above processes, the feature engine 52′ provides a list of transactions.

This list of transactions is passed as an input and processed 52g in the server using the Apriori algorithm. The Apriori algorithm runs several experiments, with various values for support and confidence. Support and confidence are defined parameters for the Apriori algorithm. Support is a value of the count of the number of occurrences of each Historical job cause number separately in the database over a first scan of the database. Confidence values come from the algorithm. Different thresholds values can be supplied to limit the Apriori output. These values for support and confidence serve as thresholds for the Apriori algorithm.

The output of the Apriori algorithm is a set of rules of the form:

X→Y, with a confidence of xx %

Using the example above assume that the Apriori algorithm determined a confidence value of 81%, thus the output would be

12→45 with a confidence of 81%

This output can be interpreted as: if historical job cause number “12” was a recent job cause number encountered at a site, then there is an 81% chance that the site may see job cause number “45” within a window of W (in the example 4 weeks). Similarly, continuing with this example and an assumed confidence the next output would be:

45→67 with a confidence of 62%

This output can be interpreted as: if job cause nos. “12” and “45” were recent job cause numbers encountered at a site, then there is an 62% chance that the site may see job cause number “67” within the window of W, etc. The feature generator 52′ converts 52g the input data into a format for the model builder.

In the above example, the model builder 52″ is configure to handle data in the following format:

Transaction_id: A unique id for every transaction

Item_id: A unique id for every item in the transaction

In example above, the transaction of job cause nos. is a vector (12, 45, 67, 18) is translated into a table of transaction Id and Item Id. Thus, the list of transactions are assigned ID's and placed in a table in association with all of the items associated with the corresponding transaction.

The Transaction_id: is a id given to a group of job cause numbers and the Item-_ID is the historical job cause number in an order as set out in the table.

| Trans_ID | Item_ID |
|---|---|
| 1 | 12 |
| 1 | 45 |
| 1 | 67 |
| 1 | 18 |
| 2 | : |
| : | : |
| : | : |

The model builder 52″ converts 52h the output from the Apriori algorithm into a rule format as above and associates confidence values 52i. The model builder 52″uses the Apriori algorithm. Apriori or other market-basket analysis techniques can be used to produce the rules and associated confidence values.

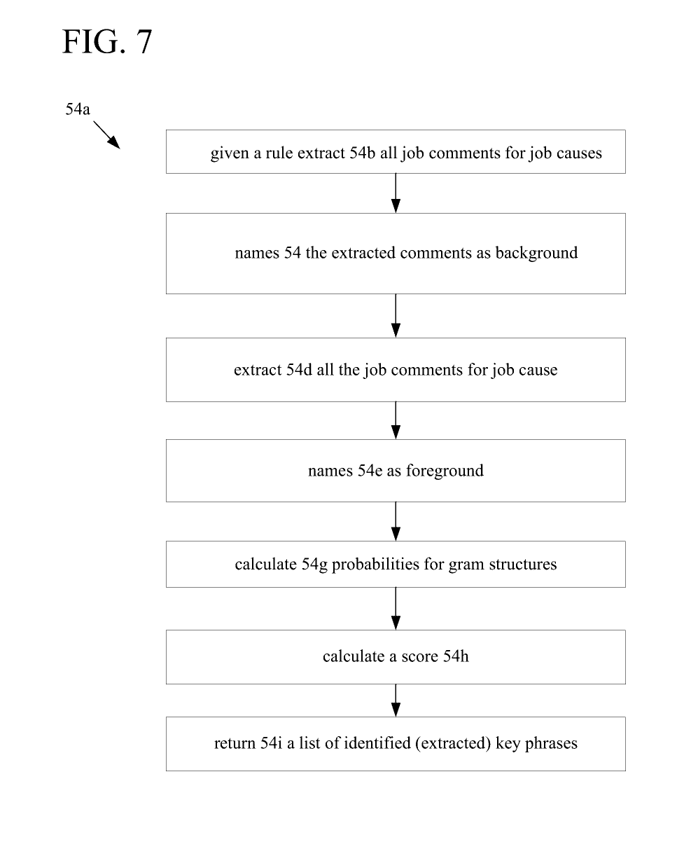

Referring now to FIG. 7, the key phrase extraction engine 54 applies a key phrase extraction process 54a on all of the rules that are generated. So for example, given a rule X→Y, extractor extracts 54b all job comments for job causes X and Y and names 54c the extracted comments as background. The extractor extract 54d all the job comments for job cause Y and names 54e it as foreground and extracts 54f unigrams, bigrams and trigrams (generalized as grams) from the foreground and calculates 54g probabilities for these grams. Probabilities for the grams are calculated as follows:

Probability (grams)=Count of the gram/Total number of unigrams

This probability is referred to as the observed probability value.

For the extracted grams from the foreground, the probabilities for the extracted grams from the foreground are obtained from the background. For those grams the expected probability value is calculated as follows:

Probability of the grams in background*Number of times the grams occurring in the foreground

The key phrase extraction module is configured for the grams following a binomial distribution. The standard deviation of a binomial distribution is square root (number of trials*p(success)*1-p(success)). The key phrase extraction module based on such a binomial distribution calculates a score 54h“z” or “z score” by calculating the standard deviation for each of the grams as

Square root (Number of time grams occurs in background (p(gram in background)*1-(p(gram in background))

The key phrase extraction module calculates the “z score” “Z” as follows:

Z=observed probability−expected probability/standard deviation

The calculated “z score” is provided for every gram in the foreground. The system is configured to display those grams with very high z scores to the user.

The prediction engine, queries the key extraction module with the list of rules that are shortlisted, e.g., rules may be filtered by the support and confidence thresholds mentioned above, or they may also be removed due to redundancies. Given those rules, the key extraction module returns 54i a list of identified (extracted) key phrases. The system generates a graphical user interface (GUI), (discussed below) that displays on a display device those key phrases in the form of a word cloud as shown in FIG. 7A.

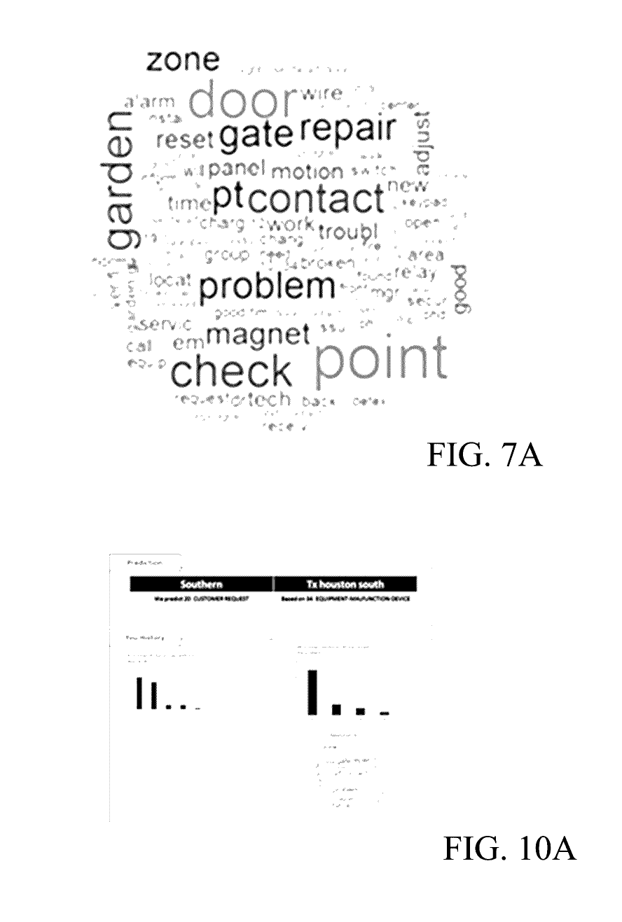

Referring now to FIG. 8, the site similarity computation module 56 processing 56a computes a list of similar sites for every other site. This site similarity module calculates 56b a set of attributes for each site. The set of attributes, can include location of the site, e.g., based on zip codes, zip code based economics of the region. “Zip code based economics of the region” could be census data aggregated at the zip code level, e.g., population or employment population, “number of zones” refers to the way sites organize a building into zones. The type of jobs performed at the site, a count of installation jobs and service jobs. Complexity of the jobs performed at the site, e.g., a count of number of line items for each job at the site. A “bag word” representation of all job comments −1 if a word is present, 2 if not. Weather details of the region where the store is located.

Using these attributes site similarity computation module represents 56c each site as a vector. With an appropriate distance metrics (e.g., a Euclidean distance for continuous values, or Jaccard's for Binary values), the site similarity computation module finds 56d distances between these vectors. Based on a threshold H for distance, the site similarity computation module assigns 56e each site to a set of its similar sites, i.e. all the sites within the threshold distance of H are assigned as the similar site for a given site, which is stored 56f.

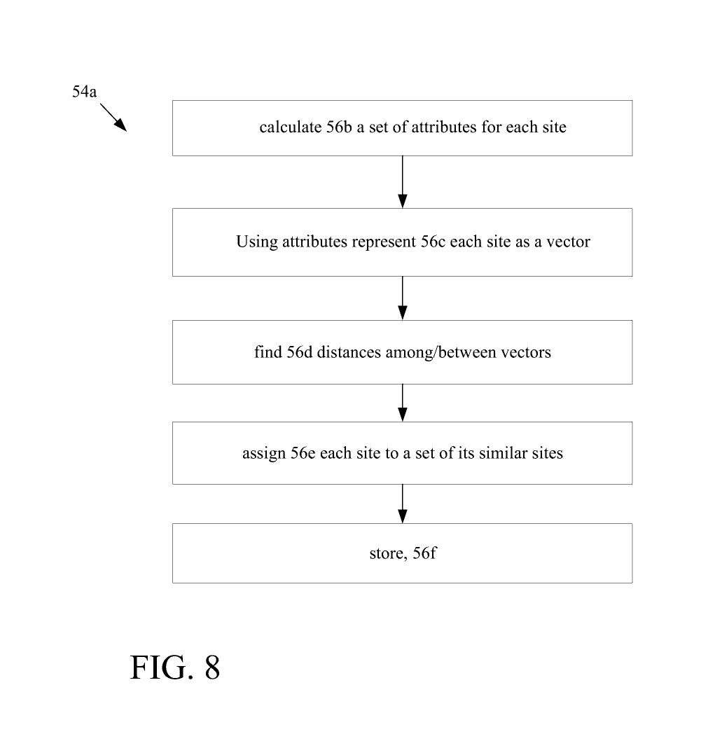

Referring now to FIG. 9, for a given site, the prediction engine 58 receives inputs from the recommendation engine 52, e.g. the rules and associated confidence values and produces an explanation for a user indicating why the recommendation engine 52 recommends handling of a certain job cause id, and produces more information on that job cause id.

The prediction engine processing 58a retrieves/receives 58b as input the list of recent job causes from a given site. These job causes can either be one or many job causes. The prediction engine scans 58c the list of rules generated by the recommendation engine 52 against recent job causes for the site. If the prediction engine finds matches 58d to any of the job causes in the Left Hand Side (LHS) for the rule, it selects 58e the Right Hand Side (RHS) of the rule as the prediction. If the prediction engine does not find any matching rules, the prediction engine goes 58f to the output of the site similarity computation module 56 and retrieves 58g a list of the top N (a configurable value) similar sites to the current site. The prediction engine 58 scans 58h the most recent jobs of those top N sites, and for those jobs again scans 58i the rules to find a match for a prediction. On finding a match the prediction engine outputs 58j RHS of those rules as the prediction. For the LHS and the RHS of all the matched rules, the prediction engine queries 58k the key phrase extraction module for key phrases associated with the rules.

In a further embodiment, for a given site, the prediction engine 58 uses the model to develop a temporal relationship based on discovered relationships between job cause numbers to determine the period from an occurrence of one job cause to the inception of the next job cause to provide a probability of the next job cause occurring as a function of time.

let “c_i” be a job cause number “i” and “t_j” is time since job cause number “j” occurred, the probability of job cause I occurring after a time t

P(e_i, t_j)=Probability of job cause number “i” occurring in time t after job cause number “j” occurred. The prediction engine processing 58a applies the time window “W” referred to above with the same or different window size and scans the job cause numbers that are within the window “W” and by using the DATE field determines time periods between two job cause numbers and forms a prediction. The feature generator groups all job history and all the job cause nos. that are within the defined window “W” as one transaction record of job cause nos. and associates a prediction to a time period between two job cause numbers, as below:
Job cause Nos. (12, 45, 67, 18).
Job cause Nos time periods. (25% within 24 hours).

In a further embodiment, for a given site, the prediction engine 58 uses the model to learn interacting relationships of the form:

P(e_i, t_j, t_k)=Probability of job cause number “i” occurring time t_j after job cause number “j” and time “t_k” after job cause “k” or
Job cause Nos. (12, 45, 67, 18).
Job cause Nos time periods. (25% within 24 hours; 18% with 36 hours).

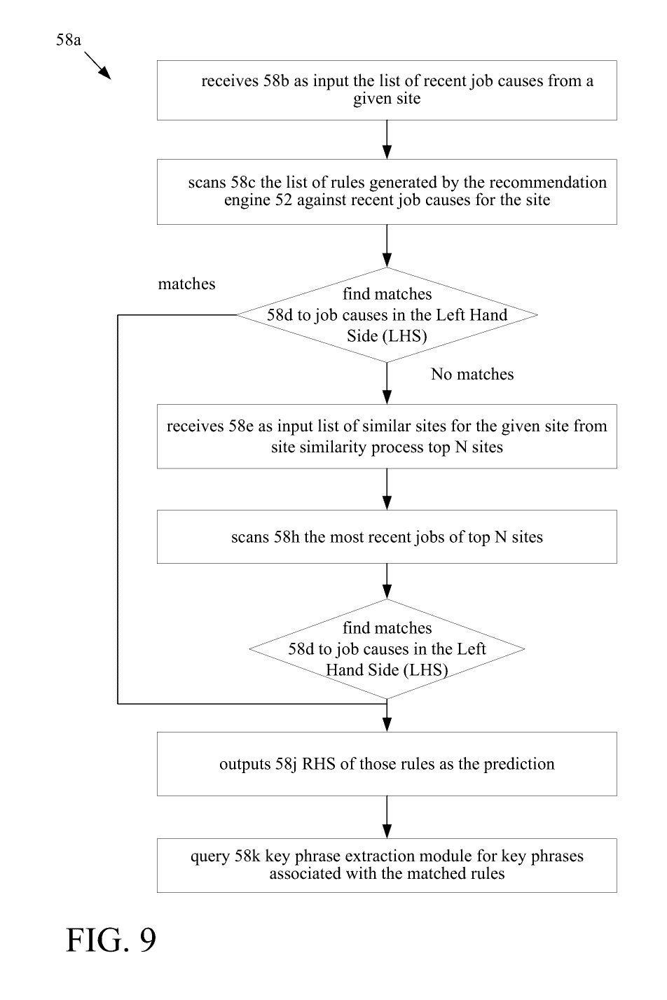

Referring now to FIG. 10, the user interface engine 60 produces a graphical user interface (GUI). The GUI is generated, by populating a retrieved template 60a with all the above information 60b from the various modules described above and sent to the dispatch system 60c to help dispatch personnel make an informed decision.

As shown in FIG. 10A, the sample GUI can include various information. In this example, the GUI is dived in into three portions. The top portion labelled as prediction gives the prediction, and the predicted job cause for a given region and site. The bottom two portions labelled as your history educates the user why this prediction is made.

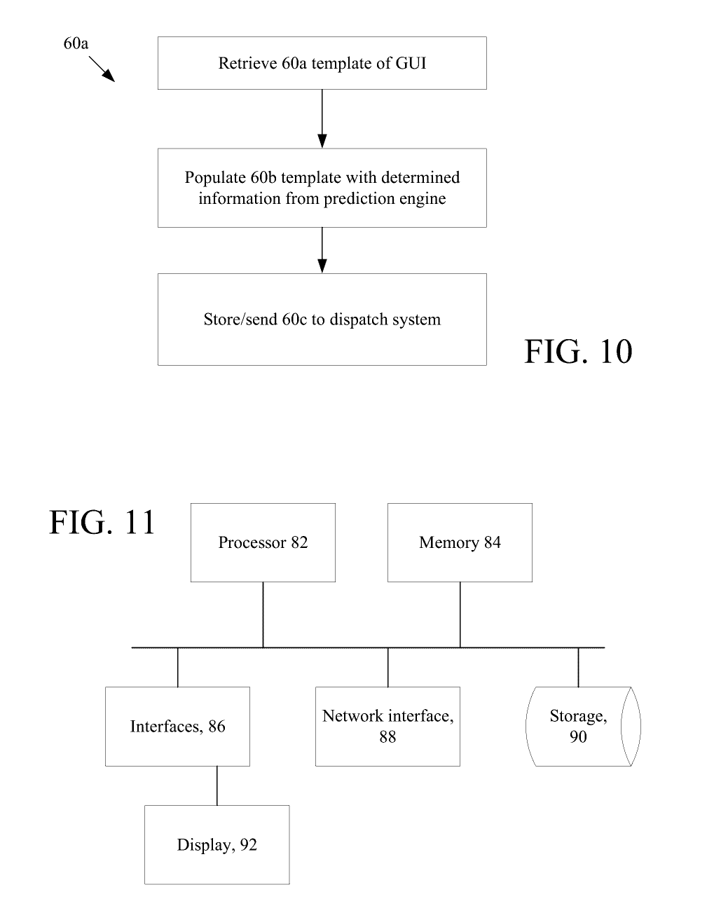

Referring to FIG. 11, dispatch devices and/or systems (generally 80) as well as servers can be of various types of computing devices capable of receiving and processing information to produce output. Such devices/systems include one or more processors 82, memory 84 interfaces 86 and a network interface 88 coupled via a bus. Also included are storage 90 and a display 92. As a server, the system can be a distributed computing system 10, a rack-mounted server and so forth. Server may be a single server or a group of servers that are at a same location or at different locations. Servers can receive information from client device user device via interfaces. Interfaces can be any type of interface capable of receiving information over a network, such as an Ethernet interface, a wireless networking interface, a fiber-optic networking interface, a modem, and so forth. Server also includes a processor and memory and a bus system including, for example, an information bus and a motherboard, can be used to establish and to control information communication between the components of server.

Processor may include one or more microprocessors. Generally, processor may include any appropriate processor and/or logic that is capable of receiving and storing information, and of communicating over a network (not shown). Memory can include a hard drive and a random access memory storage device, such as a dynamic random access memory computer readable hardware storage devices and media and other types of non-transitory storage devices.

Embodiments can be implemented in digital electronic circuitry, or in computer hardware, firmware, software, or in combinations thereof. Computer programs can be implemented in a high-level procedural or object oriented programming language, or in assembly or machine language if desired; and in any case, the language can be a compiled or interpreted language. Suitable processors include, by way of example, both general and special purpose microprocessors. Generally, a processor will receive instructions and information from a read-only memory and/or a random access memory. Generally, a computer will include one or more mass storage devices for storing information files; such devices include magnetic disks, such as internal hard disks and removable disks; magneto-optical disks; and optical disks. Storage devices suitable for tangibly embodying computer program instructions and information include all forms of non-volatile memory, including by way of example semiconductor memory devices, such as EPROM, EEPROM, and flash memory devices; magnetic disks such as internal hard disks and removable disks; magneto-optical disks; and CD ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. Other embodiments are within the scope of the following claims.

What is claimed is:

1. A work order prediction system comprises:
one or more servers computers each comprising a processor device, memory in communication with the processor device, and a storage device, the work order prediction system further comprising:
a recommendation engine that receives historical job records from customer jobs and produces a listing of rules comprising rules of the form A→B or A,B→C or A,B>C, D, where A, B, C, D are work order jobs and calculates a confidence value for a result of each of the rules;
a key phrase extraction module that receives as input free text that is parsed from the historical job records;
a site similarity computation module that clusters similar sites together;
prediction engine that generates a prediction of a work order and basis of the prediction; and
graphical user interface module that generates a graphical user interface to convey to dispatch personnel an intuitive representation of the basis of the prediction.

2. The work order prediction system of claim 1 wherein the work order prediction system analyzes historical job details for a customer site and generates the model that predicts future jobs within a limited time frame that can be expected for the customer site.

3. The work order prediction system of claim 1 wherein the recommendation engine includes a feature generator and a model builder.

4. The work order prediction system of claim 3 wherein the model builder in the recommendation engine executes an algorithm the frequent item set data mines the retrieved, historical work order records for job details for a customer site.

5. The work order prediction system of claim 4 wherein the algorithm is the Apriori algorithm that identifies frequent individual job cause numbers in the work order records and that produces rules of the form A→B or A,B→C or A,B>C, D, where A, B, C, D are job cause numbers extracted from the work order records.

6. The work order prediction system of claim 3 wherein the feature generator is further configured to:
order the historical work order records by site and then by the date of job creation;
scan sequentially the work order records and all job cause numbers that are within a preconfigured time window; and
group all job cause numbers that are within the defined time window, as one transaction record of job cause numbers.

7. The work order prediction system of claim 1 wherein the prediction engine
retrieves a list of recent job causes for a given site;
scans the list of rules generated by the recommendation engine against recent job causes for the site; when the prediction engine finds matches to any of the job causes the prediction engine selects a corresponding output of the rule as the prediction.

8. The work order prediction system of claim 7 wherein when the prediction engine does not find any matching rules, the prediction engine,
accesses output of the site similarity computation module;
scans the output for similar sites, and
scans the rules in the output to find a match for a prediction.

9. The work order prediction system of claim 7 wherein when the prediction engine determines a match, the prediction engine uses the result of the matching rule as the prediction and queries the key phrase extraction module for key phrases associated with the matched rule.

10. A computer implemented method for work order prediction, the method comprises:
forming a recommendation by one or more computer systems from received historical job records from customer jobs comprising rules of the form A→B or A,B→C or A,B>C, D, where A, B, C, D are work order jobs with a calculated a confidence value for a result of each of the rules;
producing by the one or more computer systems a listing of the rules;
extracting by the computer system one or more key phrases that are received as input free text parsed from the historical job records;
producing by the one or more computer systems a site similarity computation that clusters similar sites together;
generating by the one or more computers a prediction of a future work order and basis of the prediction; and
generating by the one or more computers a graphical user interface to convey to dispatch personnel a representation of the basis of the prediction.

11. The method of claim 10 further comprises:
analyzing historical job details for a customer site; and
generating the model that predicts future jobs within a limited time frame that can be expected for the customer site.

12. The method of claim 10 wherein the recommendation engine includes a feature generator and a model builder.

13. The method of claim 10 further comprising:
executing by the one or more computers an algorithm that determines from the retrieved, historical work order records job details for a customer site.

14. The method of claim 13 wherein the algorithm is the Apriori algorithm that identifies frequent individual job cause numbers in the work order records and that produces rules of the form A→B or A,B→C or A,B>C, D, where A, B, C, D are job cause numbers extracted from the work order records.

15. A computer program product tangible stored on a computer readable hardware storage device, the computer program product for providing a work order prediction and comprising instructions to cause one or more servers computers each comprising a processor device, memory in communication with the processor device, and a storage device to:
receive from a database historical job records from customer jobs;
produce a recommendation as a listing of rules of the form A→B or A,B→C or A,B>C, D, where A, B, C, D are work order jobs and an associated a confidence value for a result of each of the rules;
extract key phrases from free text that is parsed from the historical job records;
produce site similarity clusters of similar sites into groups of similar sites;
form a prediction of a work order and basis of the prediction; and
generate a graphical user interface to convey to dispatch personnel a representation of the basis of the prediction.
